(19) United States
(12) Patent Application Publication
(10) Pub. No.: US 2007/0005833 A1
(43) Pub. Date: Jan. 4, 2007

(54) Transmit buffers in connection-oriented interface

(76) Inventor: Pak-Lung Seto, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/171,981

(22) Filed: Jun. 30, 2005

(51) Int. Cl. G06F 5/00; G06F 3/00

(52) U.S. Cl. 710/52

(57) ABSTRACT

A connection-oriented protocol controller has a prefetch engine to obtain payload data that is destined to a remote node, before a connection is established with the remote node. A number of buffers are provided. Each buffer is associated with a different remote node with which a connection is to be established. The payload data is to be sent to that node from its associated buffer. Other embodiments are also described and claimed.

An embodiment of the invention is directed to a non-blocking transmit path in a connection-oriented interface. Other embodiments are also described and claimed.

### BACKGROUND

A connection-oriented interface is the hardware and software that enables a certain type of data communications between two devices of a system. The system may, for example, be a computer system. In a typical computer system, components such as the host processor and memory, I/O controller, and peripheral devices such as mass storage devices, may communicate with each other through a connection-oriented I/O interface and its associated protocols. Examples of such interfaces include Serial Attached Small Computer System Interface (SCSI) (SAS), Serial Advanced Technology Attachment (SATA), and Fibre Channel Arbitration Loop (FCAL). In those instances, a device wishing to communicate with another device is to first establish a connection with the selected, remote device, before information or payload data can be exchanged between the two devices. Typically, communication proceeds through three phases: connection establishment, data transfer, and connection release. This is in contrast to a connectionless protocol, which is a data communication method in which communication occurs between devices with no previous set up.

The connection-oriented protocol may support upper layer services, namely a transport layer data communication service, that allows an initiator device to send data in a continuous stream to a target device. Note that a connection-oriented interface may support full duplex communications, in which data can travel in both directions at once.

In a typical storage application, the computer system has a host that is running an application program or operating system and that needs frequent access to non-volatile, mass storage in the system. The host may include a processor, main or system memory, and perhaps a system interface component, such as a system chipset or I/O controller. According to SAS, an interface is defined between the host and a number of mass storage devices (e.g., random access memory (RAM) disks, rotating magnetic or optical disk drives, tape drives, etc.) that can be scaled as the storage needs of the system increase. The interface has a SAS controller (also referred to as a host controller) that receives requests from the host, and makes the necessary translations and manages the connections needed to either write or read from the appropriate devices in the mass storage. For example, the host may request that a particular file be stored in a target storage device. The controller translates this into lower level requests that might, for example, spread the data to be written over one or more disk drives. This also allows the controller to implement availability and reliability algorithms that allow for easy recovery from a failed disk drive, or that verify and correct for any errors during a read or write. Off loading such functions from the host allows the host to focus on other tasks, thereby improving performance of the overall system.

There are several different techniques for providing increased connectivity to an I/O interface, so that additional storage devices may be added. In one such technique, the controller is fitted with multiple, protocol engines that can operate in parallel. Each protocol engine may be capable of supporting multiple storage I/O protocols, e.g. SAS, SATA, as well as perhaps Fibre Channel. The controller has a host interface on one side, and one or more storage I/O ports on the other. See U.S. patent application Ser. No. 10/742,029, filed Dec. 18, 2003, entitled “An Adapter Supporting Different Protocols”. That patent application also shows another technique where a storage I/O port of a protocol engine may be attached to an adjacent, expander device.

When a protocol engine receives a request from the host to write a file to mass storage, it tries to establish a connection to one or more mass storage devices through its I/O port. The protocol engine has a transmit data path through which all data, received from the host and to be sent to a remote device, travels. This path includes a segment that is in the transport layer, as well as a segment that is in a lower layer, namely a port layer. A first in first out (FIFO) buffer may be used to temporarily store the data received from the host, while waiting for the connection to be established.

Most connection-oriented protocols allow for any device in the system to request a connection at essentially any time, to be established to another device. For example, while the controller is requesting a connection to a device B, a further device C can also request a connection at the same time to the controller. If device C has higher priority, then the controller will have to “drop” its connection request to device B, grant the connection request from device C, and service, through its I/O port, device C rather than device B. In that case, the stored data in the FIFO buffer will block the transmit path for servicing device C. That is because the FIFO buffer requires that the data already stored in it (for device B) be removed, before it can pass through it any subsequently received data (for device C).

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of part of a communications protocol controller, according to an embodiment of the invention.

FIG. 2 is a diagram of the different layers involved in an example protocol controller.

FIG. 3 is a diagram of a host bus adapter card with a storage controller.

FIG. 4 is a diagram of a motherboard with an installed storage controller.

FIG. 5 is a diagram of a sequence of operations depicting establishment of a connection between devices, according to an embodiment of the invention.

FIG. 6 is a diagram of another connection establishment sequence, according to another embodiment of the invention.

### DETAILED DESCRIPTION

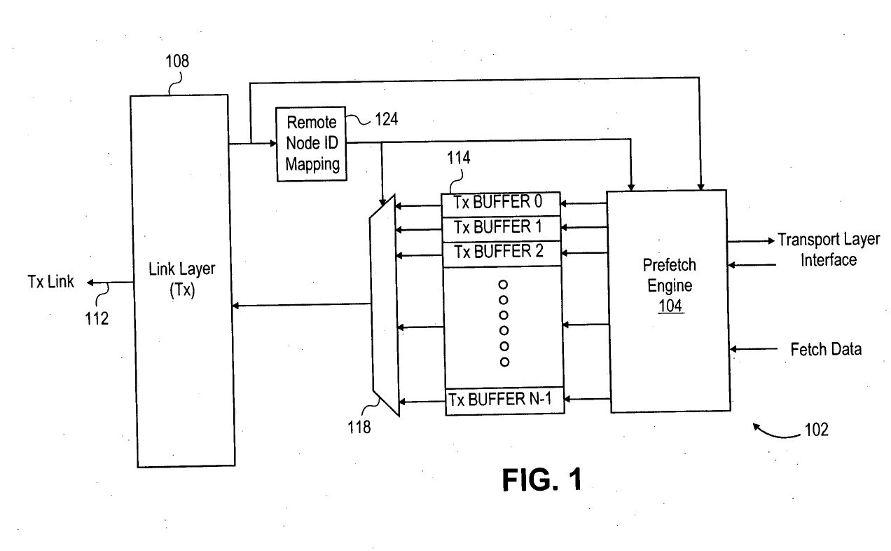

Beginning with FIG. 1, a block diagram of part of a connection-oriented protocol controller is shown, according to an embodiment of the invention. A prefetch engine 104 is to obtain payload data (also referred to as fetched data) that is destined to a remote node, before a connection is established with that node. The node may be either directly attached to the link layer 108 through one or more transmit (Tx) links 112, or it may be indirectly coupled through one or more expanders or fabric switches (not shown). The prefetched data is fed into a number of transmit buffers 114 (here, N buffers 0, 1, 2, . . . N−1). Each buffer 114 is associated with a different, set of one or more remote nodes with which a connection is to be established, prior to payload data being sent to that node from its associated buffer 114 (and not from any others). The output of each buffer 114 feeds, in parallel, a multiplexer 118 whose single output is fed to the link layer 108 of the controller, for transmission in the direction of the remote node. The link layer 108 receives payload data for transmission, from only one buffer 114 at a time. In other words, once a connection has been established with a remote node, only data from the buffer associated with that node is selected (via the multiplexer 118) to be fed to the link layer 108. Each buffer 114 may be a first in first out (FIFO) buffer, also referred to as a prefetch queue, to support in order transmission as required by many protocols.

The multiplexer 118 has a select input that is driven by remote node identification (ID) mapping logic 124. Each remote node, may be either a remote device, a remote port within a device, or a gateway port (e.g., a FL Port which is a port that connects a FCAL to a fabric). Each remote node has a different identifier, separate from its globally unique address. In a SAS embodiment, this identifier is referred to as a remote node index (RNI) which is different from the typical 64-bit SAS address in that it is much smaller and therefore presents a simpler way for hardware to index into the internal data structures of the controller. The identifier may alternatively be Port “00” which is typically used for the FL Port in a Fibre Channel Storage Area Network (SAN) to access public devices. The link layer 108 detects the current remote node with which a connection has just been established, and provides this information to the mapping logic 124. The mapping logic 124 translates the RNI of the now connected, remote node into the appropriate multiplexer select signal so that the corresponding buffer 114 is selected for transmission through the link 112.

The number of buffers 114 (N) should be selected in view of practical limitations, rather than being set equal to the maximum number of devices allowed by an interface specification. For example, a relatively recent version of FCAL allows up to 127 arbitrated loop physical addresses (AL-PA) to be coupled to the controller in a single Fibre Channel Private Loop domain. However, from a practical point of view, if the controller is part of a server machine that provides built-in mass storage, then a much more limited number of mass storage devices, such as hard disk drives, may be needed within the server machine. In that case, a controller with twenty FIFO buffers would probably work well with FCAL storage devices. In general, the controller should be designed with a sufficient number of buffers 114 that reduces the probability of a “cache miss”, i.e. receiving transmit data for a remote node that is not assigned its own buffer. The number of buffers is therefore implementation specific, and depends on the number of remote nodes that are expected to be serviced by the local port of the controller. Each implementation may trade off the number of buffers 114, with the cost of providing additional buffers, as well as the capability of absorbing the performance impact caused by a cache miss.

Some advantages of the protocol controller design in FIG. 1 will become apparent, when considering the following example of three devices seeking to communicate with each other. Assume that device A is requesting a connection with device B (because device A has information to send to device B). Device A may start to prefetch that information from, for example, host memory. This allows device A to get ready to transmit the information as soon as the connection request has been granted, helping reduce idle time on the links that will connect the two devices, after the connection has been established between the two devices.

However, device A will typically have to drop its connection request to device B, if there is an incoming connection request from a higher priority device, device C. That causes the following two issues. First, since the connection to device C is unexpected from the point of view of device A, device A probably does not have any data available to transmit to device C, immediately after the connection has been established. Accordingly, idle time appears on the transmit links to device C, while the data is being fetched.

The second issue is that device A will have to either discard the prefetched data that is destined for device B, since the connection request to device B has been dropped, or device A can leave the prefetched data in its transmit data path (while waiting to establish a connection to device B). Discarding the data wastes host memory bandwidth and may also complicate direct memory access (DMA) context processing implementations. Also, in the case of a conventional protocol controller, leaving the prefetched data in the transmit data path will typically block the path for transmitting any data to device C, because the path is in the nature of a first in, first out (FIFO) structure. In other words, since the data for device B was enqueued before any data destined to device C became available, the data for device B must be transmitted before any data for device C.

By equipping device A with the multiple transmit buffers and prefetch engine as depicted in FIG. 1, a number of advantages are possible. First, the amount of needed host/memory bandwidth may be reduced. The multiple, transmit buffers help reduce the likelihood of having to discard prefetched data, if the connection request for the prefetched data is not granted. In addition, idle time on the transmit link after a requested connection has been established may be reduced or perhaps eliminated, because prefetched data is available in the buffer for immediate transmission to the remote node. Also, the chances of blocking the transmit data path of the controller with the prefetched data associated with an earlier request may be reduced.

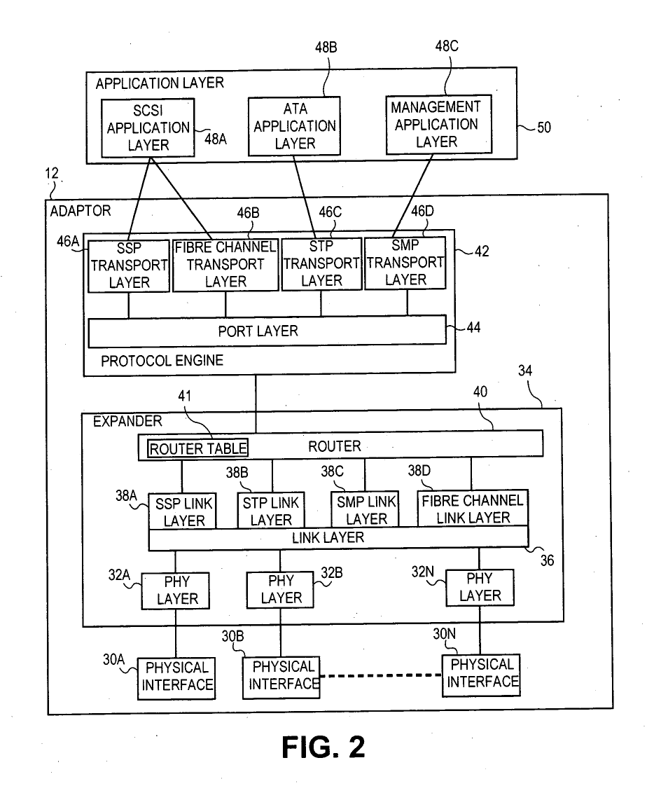

Referring now to FIG. 2, a block diagram of the different layers involved in an embodiment of the invention is shown. The layers are illustrated in the context of an adapter 12, which may be a host bus adapter on which the protocol controller and an embedded expander 34 may be installed, and an application layer 50. Starting at the lower layers and moving up, there may be one or more physical interfaces 30a, 30b . . . which may include the driver and receiver circuitry and connector hardware that are coupled to the transmission medium to form one or more links to which an adjacent device (not shown) is attached. The physical interfaces may be different, for example, one may be in accordance with SAS/SATA while another may be in accordance with Fibre Channel. With SAS, the attachment of two devices may be over one or more point-to-point links, where each link is a bi-directional, serial communication path. A “port” of a device may be associated with one or more links over which the device communicates with an adjacent device.

Communicating above each physical interface 30 is a phy layer 32a, 32b . . . . In this case, the phy layer 32 is physically inside the expander 34 which may be in a separate integrated circuit package. The phy layer 32 may perform encoding such as 8b10b, as well as a serial to parallel conversion. The phy performs serial to parallel conversion of data, so that parallel data is sent to the layers above the phy, and serial data is transmitted and received through the transmission medium to and from an adjacent device. Thus, for example, a 10-bit character that is serially received is collected and aligned into an 8-bit character before being sent up to the next higher layer.

Typically, the phy layer 32 decodes the characters, and then forwards the characters up to the next layer, the link layer 36. In this embodiment, the link layer 36 recognizes how a group of characters may form a frame. The link layer may also recognize frames of several different protocols. In this example, there is a serial SCSI protocol (SSP) link layer 38a to process SSP frames. Another link layer may be a serial tunneling protocol (STP) layer 38b. Yet another may be a serial management protocol (SMP) layer 38c. Finally, the embodiment of FIG. 2 also has a Fibre Channel link layer 38d that supports the receipt and transmission of Fibre Channel frames. A simpler, less expensive alternative is to design the expander to support only one of these I/O interconnect protocols in dedicated systems.

The expander 34 also includes a router 40 that routes a frame received over one phy layer to another phy layer, based on the destination address of the frame. Given the embedded nature of this expander 34, the same type of link and phy layers may not be needed for the attachment to the protocol engine 42. The router 40 maintains a router table 41 that provides an association between port-layer destination addresses and phy layers 32.

Although the unit of information that is being processed by the upper layers is referred to here as a “frame” this is simply used as a convenience to alternatively refer to a primitive, a packet, and an SAS frame per se, or any other unit of information used by layers above phy.

The transport layers 46a, 46b, . . . include predominantly software that initiates, maintains, and tears down a point-to-point connection between an initiator and a target device, to allow for the transmission of information between devices so that the information arrives in an uncorrupted manner and in the correct order. The transport layer is thus said to either open or dissolve a connection between devices. Examples of the transport layer protocols include those defined in SAS, SATA, and/or Fibre Channel, as well as others known in the art.

The protocol engine 42 in this example implements a number of transport layers including SSP transport layer 46a, Fibre Channel transport layer 46b, STP transport layer 46c, and SMP transport layer 46d. The port layer 44 interfaces between the link layers 38a, 38b . . . in the expander, and the transport layers 46a, 46b in the protocol engine, via the router 40 of the expander.

At the highest layer of the diagram in FIG. 2, an application layer 50 may include different types of application layers depending on the protocol to be used. For example, an SCSI application layer 48a provides network services to end users of SAS and Fibre Channel devices on the one hand, and communicates with the lower transport layers 46a and 46b on the other. An ATA application layer 48b similarly provides network services to end users of ATA devices on the one hand, and communicates with the lower layer, STP transport layer 46c in the adapter. In this embodiment, there is also a management application layer 48c which communicates with the lower, SMP transport layer 46d in the adapter. The application layer 50 may be entirely software that is running in the host, or running in a separate processor and embedded memory combination within the adapter 12 (not shown).

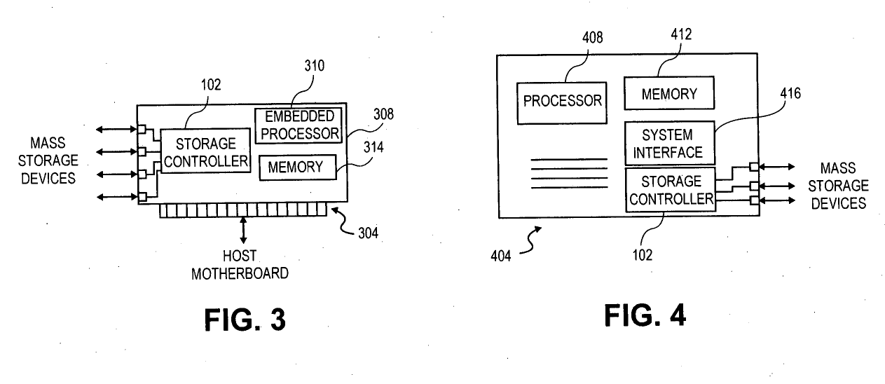

The storage controller described above may be integrated onto a carrier substrate, such as a host bus adapter card 304 depicted in FIG. 3. The card 304 may comprise a carrier substrate such as a printed circuit board 308 on which are installed separate integrated circuit packages for the storage controller 102, and optionally an embedded processor 310 and its associated program memory 314. Multiple mass storage devices (not shown) may be coupled to the storage controller 102, either attached directly to a port of the storage controller, or indirectly via one or more expander devices or a fabric switch (not shown).

In another embodiment of the invention, the storage controller 102 may be integrated into another type of carrier substrate, namely a computer system motherboard 404. In such a system, a host processor 408 is installed together with main memory 412 and possibly a system interface chipset 416, on the same carrier substrate as the storage controller 102. As with the adapter card 304, multiple mass storage devices may be coupled to the storage controller 102 in a similar manner, that is either through direct attachment to an external port of the storage controller, or through one or more expander devices or a fabric switch. In these embodiments, the storage controller 102 may wish to write data to multiple, mass storage devices and may send requests to all of them to establish a connection. The controller then waits for an acceptance before transmitting the write data to the accepting device. Meanwhile, the controller prefetches the write data for the mass storage devices, from either the memory 314 or host memory 412. In such an embodiment, the prefetch engine 104 (FIG. 1) may be a prefetching DMA engine, having direct access to memory. The DMA engine is an example of a data mover that may include logic for moving data from a source to a destination without using the core processing module of a host processor or otherwise does not use cycles of a processor to perform data copy or move operations. By using the data mover for transfer of data, the processor may be freed from the overhead of performing data movements, which may result in the host processor running at much slower memory speeds compared to the core processing module speeds

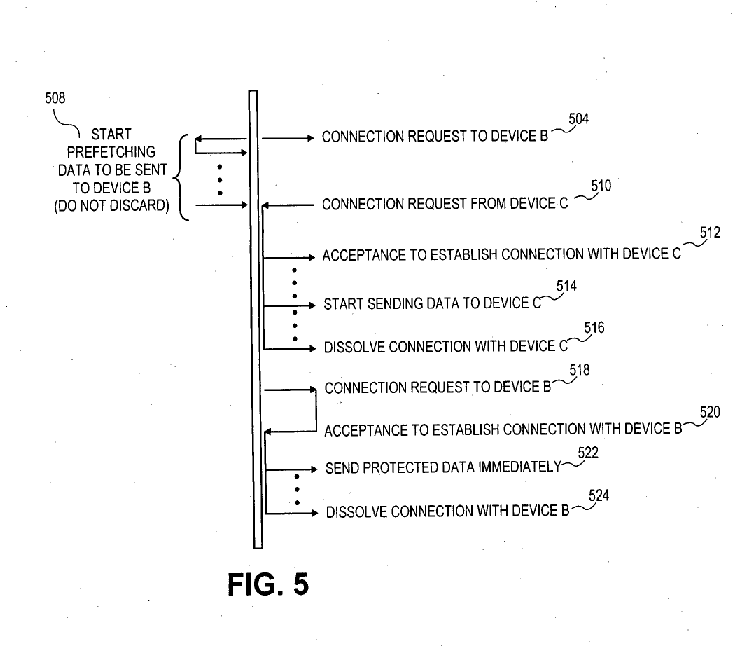

Turning now to FIG. 5, a sequence of operations depicting establishment of connections between a source and multiple destinations, according to an embodiment of the invention is illustrated. These operations are from the point of view of the source, which may be a device A, such as a controller, that has the ability to prefetch the data that is to be sent to a destination, e.g. a remote device. Operation may begin with sending a connection request to a destination, e.g. device B (504). Either before or after sending that connection request, device A may start prefetching the data that is to be sent (508). The prefetched data need not be discarded from device A, regardless of whether or not the connection request to device B is later dropped. Next, a connection request is received from device C (510). Since device C has higher priority of service than device B, an immediate acceptance is sent, to establish a connection with device C (512). Device A then starts to service that destination (device C), by starting to send data through its I/O port (514). Meanwhile, even if an acceptance is received from device B, the acceptance is essentially ignored by device A such that the connection request to device B may timeout. Device C, meanwhile, continues to be serviced until the connection can be dissolved (516).

Thereafter, device A sends another connection request to device B (518). This time, an acceptance is promptly received, which establishes the connection (520). Since the prefetched data (operation 508) has not been discarded, device B may be immediately serviced by being sent the prefetched data (522). Once device B has been properly serviced, the connection with it may be dissolved (524). Device B is thus serviced with minimal delay (because of the prefetched data being available).

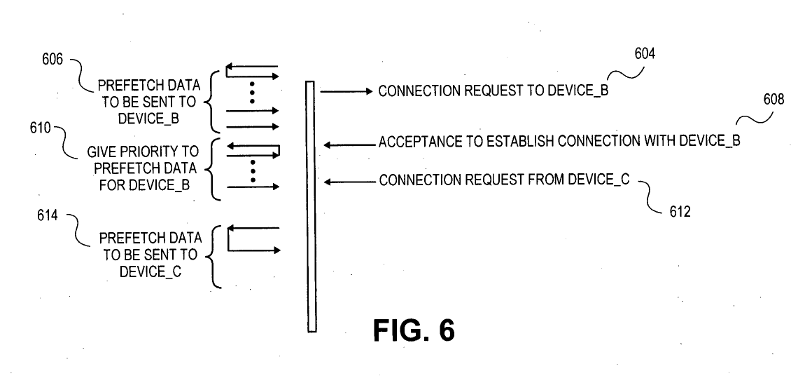

Turning now to FIG. 6, a sequence of operations for establishing connections is shown, according to another embodiment of the invention. In this embodiment, as soon as a connection is established for the local I/O port, the selected destination, e.g. remote node, is assigned the highest priority (to be serviced by the prefetch engine) so as to attempt to sustain the transfer speed over the links that connect to it. Note that so long as a connection has not been established, the prefetch engine may prefetch data for any of the remote nodes according to any suitable algorithm, e.g. round robin. However, as soon as a connection is established with a particular remote node, that one will have the highest priority for being serviced by the prefetch engine.

In the example of FIG. 6, before a connection request is sent to device B (604), device A starts to prefetch data to be sent (606). Thereafter, once an acceptance is received to establish the connection (608), device A assigns highest priority to prefetching data for the connection that has just been established with device B (610). This will help keep the stream of prefetched data coming from the host, as the available prefetched data begins to be sent to device B. Thus, even if a connection request is then received from a normally higher priority device, namely device C (612), while continuing to prefetch data for device B (610), servicing for device C, including any prefetching of data to be sent to device C (614) may be delayed (for a period of time that depends on the backend data transfer bandwidth), until after prefetching has ended for the device B connection. Some protocols, like FCAL, provide a hint as to which will be the next highest priority request pending. In that case, if the prefetch buffer or queue to device B is full, or if there is available backend data transfer bandwidth, the prefetch unit can start to service device C, which has the highest priority to be the next, connected remote node. Thus, the unsolicited, connection request from device C may, or may not be, immediately serviced. In either case, the transmit links of device A do not remain idle, because they are servicing the existing connection with device B. Note that the prefetch unit may start servicing device C, though not transmitting to it (because device A is still connected to device B). In addition, assigning priority to continue to prefetch data for device B will help maintain the stream, thereby improving transmit link bandwidth usage (while device A is connected to device B).

Referring back to FIG. 1, each buffer 114 may be designed with a certain data prefetch limit or threshold. For example, if a given buffer 114 becomes sufficiently full during prefetching, according to some preset threshold, then the servicing priority of the prefetch engine may rotate to service another remote node. It may be expected that the prefetch engine will be able to obtain data (and store it in a buffer 114) faster than the rate at which the data may be transmitted by the link layer. Thus, the prefetch unit may go round and round, prefetching frames for the different, remote nodes, without a connection being requested or established (e.g., because no prefetch queue stores a threshold number of prefetched frames required to issue a connection request).

Another way to view the servicing priority of the prefetch engine is to consider that a port or link of the controller 102 has a status that can be either “connected” or “connection requesting”. According to an embodiment of the invention, the prefetch engine 104 is designed such that its service priority is based on the connected status, and not the connection requesting status. In other words, the prefetch engine may give highest servicing priority to the first port that changes from connection requesting to connected. Secondary priority may be given for whichever remote node that is the next candidate for a connection (if the identity of that requestor is known).

As described above, according to the various embodiments of the invention, a connection-oriented protocol device can prefetch data to be transmitted to more than one remote node, to anticipate the data transfer if a connection is established with any of those remote nodes. This is achieved without blocking the transmit path of the device, where an earlier requested connection fails to establish (to transmit the prefetched data).

Some advantages of the invention may prove more apparent in external storage systems having a number of mass storage devices (e.g., hard disk drives) that may be part of a redundant array of inexpensive disks (RAID) set. That is an example of an implementation in which there are a relatively large number of target devices that may communicate with a storage controller that is part of, for example, a host bus adapter. In such a system, there is a relatively high probability that a connection request from the controller may not be granted (e.g., because a particular disk drive is busy). Also, certain applications may benefit more than others, such as transaction processing which involves smaller I/O transfer size, numerous connection set up and tear downs per second, as compared to, for example, video on demand or data backup which involves mostly larger I/O transfer sizes with longer connection durations.

The invention is not limited to the specific embodiments described above. For example, in FIG. 1, although a single Tx link 112 is shown, the controller may alternatively have multiple Tx links feeding the same port of a target device, for greater throughput. In that case, the link layer 108 could spread the payload data received from a buffer 114 over multiple links. Accordingly, other embodiments are within the scope of the claims.

What is claimed is:

1. An apparatus comprising:
a connection-oriented protocol controller having a prefetch engine to obtain payload data, destined to a remote node, before a connection is established with said remote node, and a plurality of buffers each being associated with a different remote node with which a connection is to be established, the payload data to be sent to the remote node from its associated buffer.

2. The apparatus of claim 1 wherein the controller has a programmable, prefetch threshold for each buffer, wherein no connection request is sent to a remote node associated with a buffer unless the buffer has reached the threshold.

3. The apparatus of claim 1 wherein the prefetch engine is to obtain the payload data from host memory via direct memory access (DMA).

4. The apparatus of claim 1 wherein the prefetch engine is to start obtaining payload data for one or more of the different remote nodes before any connection to send that data to the remote node has been established, if the controller determines that a prefetch buffer is assigned to that node, and assign highest priority to the first node for which a connection is established so that the prefetch engine continues to prefetch for said first node after the connection to it is established.

5. The apparatus of claim 1 wherein a link or port of the controller has a status that can be one of (1) connected, (2) connection requesting, and (3) next connecting requestor, and wherein a servicing priority for the prefetch engine is based on the connected status or the next connecting requestor status, and not the connection requesting status.

6. A storage system comprising:
a processor; and
memory coupled to the processor and containing instructions that when executed by the processor request an access to mass storage;
a storage controller having a data mover engine to prefetch a frame of data from the memory that is destined to mass storage and store the prefetched frame in one of a plurality of buffers, each buffer being associated with a different, connection-oriented port of the controller to store the frames that are to be transmitted through its associated port; and
a plurality of mass storage devices coupled to one or more of the ports of the controller.

7. The system of claim 6 wherein each of the plurality of mass storage devices with which a connection to a controller port is to be established is assigned a different, remote node index (RNI) or gateway port number, and each buffer is indexed by a different RNI.

8. The system of claim 6 further comprising a system motherboard on which the controller is installed directly.

9. The system of claim 6 further comprising a system motherboard and a host bus adapter attached to the motherboard, wherein the controller is part of the host bus adapter.

10. A method comprising:
sending a request to a first destination, to establish a connection with the first destination in accordance with a connection-oriented protocol;
before receiving a response from the first destination to the request, prefetching data to be sent to the first destination;
while prefetching said data, and before receiving a response from the first destination to the request, receiving a connection request from a second destination; and
responding to the request from the second destination to establish a connection with the second destination, and then sending data to the second destination over the established connection while buffering the prefetched data.

11. The method of claim 10 wherein the connection-oriented protocol is one of SAS, SATA, and Fibre Channel.

12. The method of claim 10 wherein the request is sent to the first destination by a storage controller in a computer system, and the first destination is a mass storage device coupled to the controller via an I/O interconnect of the system.

13. The method of claim 10 further comprising:
sending another request to the first destination to establish a connection, while the prefetched data remains buffered, after the second destination has been serviced and the connection to the second destination has been dissolved.

14. The method of claim 12 wherein prefetching data comprises sending a direct memory access (DMA) request to host memory in the system.

15. A method comprising:
sending a request to a first destination, to establish a connection with the destination in accordance with a connection-oriented protocol;
prefetching data to be sent to the first destination, prior to the connection being established; and
prior to receiving any other connection request, receiving an acceptance from the first destination to establish the connection; and then
giving priority to continue to prefetch data to be sent to the first destination over the established connection, even while another connection request is received.

16. The method of claim 15 wherein the prefetching starts before the request is sent, and a plurality of prefetched data frames are enqueued prior to sending of the request.

17. The method of claim 15 wherein the request is sent to the first destination by a storage controller in a computer system, and the first destination is a mass storage destination coupled to the controller via an I/O interconnect of the system.

18. The method of claim 17 wherein prefetching data comprises sending a direct memory access (DMA) request to host memory in the system.

19. The method of claim 15 further comprising:
determining whether a next requestor has been given secondary priority, and whether a prefetch buffer has been assigned to it and, if there is sufficient backend bandwidth, start prefetching data to be sent to the next requestor.
